(19) United States
(12) Patent Application Publication
(10) Pub. No.: US 2021/0178681 A1
(43) Pub. Date: Jun. 17, 2021

(54) 3D SCREEN PRINTING SYSTEM FOR PRINTING THREE-DIMENSIONALLY SHAPED STRUCTURES

(71) Applicants: Exentis Group AG, Stetten (CH); EKRA Automatisierungssysteme GmbH, Bönnigheim (DE)

(72) Inventors: Srdan Vasic, Horgen (CH); Markus Engel, Moosen/Vils (DE); Franz Plachy, Brackenheim (DE); Hubert Reinisch, Freiberg am Neckar (DE)

(21) Appl. No.: 16/762,258

(22) PCT Filed: Nov. 9, 2018
(86) PCT No.: PCT/EP2018/080795

§ 371 Date: Jul. 1, 2020

(30) Foreign Application Priority Data
Nov. 10, 2017 (EP) 17201058.9

(51) Int. Cl. B29C 64/232; B33Y 30/00; B29C 64/245

(52) U.S. Cl. CPC B29C 64/232; B29C 64/245; B33Y 30/00

(57) ABSTRACT

A printing system for printing three-dimensionally shaped structures, in particular on substrates such as circuit boards, wafers, solar cells, carrier substrates, printing tables, carrier plates, sintering plates or the like, has at least one printing device with a printhead having a squeegee device and a screen receptacle associated with the squeegee device for receiving a printing screen. A screen provision device has at least one screen magazine for storing multiple printing screens and a conveying device for conveying a printing screen from the screen magazine to the screen receptacle and from the screen receptacle to the screen magazine.

### PRIORITY AND CROSS REFERENCE TO RELATED APPLICATIONS

This application is the U.S. National Phase application under 35 U.S.C. § 371 of International Application No. PCT/EP2018/080795, filed Nov. 9, 2018, designating the U.S. and published as WO 2019/092193 A1 on May 16, 2019, which claims the benefit of European Application No. EP 17201058.9, filed Nov. 10, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The invention relates to a printing system for printing three-dimensionally shaped structures on substrates.

### BACKGROUND

Printing systems of the type mentioned at the outset are known from the prior art. 3D printing methods enjoy an ever increasing popularity, because complex three-dimensional structures can be produced cost-effectively in a short time, wherein such printing methods are not only limited to prototypes but are also applied to the production of finished products in the meantime. Thereby, different techniques are used. Frequently, lasers are used for the layer-by-layer molding of plastic structures. For the production of electrically conductive structures from metallic materials, carrying out screen printing processes is known. For this purpose, a printing material in a suitable form is applied to a printing screen, which is pressed by means of a scraper blade of a scraper device through the screen onto a substrate. DE 20 2013 004 745 U1 already discloses a system for the production of three-dimensional screen printing.

### SUMMARY

The invention relates to a printing system for printing three-dimensionally shaped structures on substrates, in particular printed circuit boards, wafers, solar cells, carrier substrates, printing tables, carrier plates, sintering plates or the like, which has at least one printing device having a print head which has a scraper device and a screen receptacle associated with the scraper device for receiving a printing screen. It is in particular a 3D screen printing system for printing three-dimensionally shaped structures.

### BRIEF DESCRIPTION OF THE DRAWINGS

The invention will be explained in more detail below with reference to the drawings. Shown for this purpose are FIGS. 1-4.

FIG. 1 shows an advantageous printing system in a simplified representation,

FIG. 2 shows a screen magazine of the printing system in a simplified representation,

FIG. 3 shows an exemplary embodiment of the printing system in a plan view, and

FIG. 4 shows another exemplary embodiment of the printing system in a top view.

### DETAILED DESCRIPTION

The task of the invention is to provide an improved printing system, by means of which even complex three-dimensional structures can be produced in a simple and timely manner.

The task underlying the invention is achieved by a printing system having the features of claim 1. This has the advantage that a complex three-dimensional structure can be produced without a plurality of printing devices being necessary for this purpose, and without the substrate carrying the structure having to be removed from a printing device for producing the complete structure and inserted in another printing device. As a result, the production time is shortened and resources, in particular also with respect to the space required for the production, are saved. According to the invention, this is achieved in that the printing system comprises a screen provisioning device which has a screen magazine for storing a plurality of print screens and a transport device for transporting a printing screen from the screen receptacle to the screen magazine, on the one hand, and a selected printing screen from the screen magazine to the screen receptacle, on the other hand. The printing device is thus capable of selecting different printing screens from a screen magazine and forming the basis of the printing process, whereby different and highly complex three-dimensional structures can be printed in a simple manner with the same printing device using differently designed printing screens. For this purpose, for example, a selected printing screen is first removed from the screen magazine by means of the transport device and is arranged in the screen receptacle, and a first printing process is carried out. The printing screen is removed from the screen receptacle and fed back to the screen magazine, so that in the second step the transport device removes a second printing screen from the screen magazine and places it in the screen receptacle. The subsequent second printing process has a second printing layer, which differs from the first printing layer, for example on account of the design of the printing screen, so that three-dimensionally shaped structures are produced. In this case, the number of printing layers can be freely selected and their height can also be variable. Of course, two or more printing processes can also be carried out with one and the same printing screen directly one behind the other.

In order for the distance between the printing screen and the substrate to be as low as possible during a printing process, the printing table carrying the substrate and/or the printing head are preferably adjustable in height in order to be able to vary the distance between the printing screen and the printing table. By increasing the height after each printing process, the printing layers can thus be layered on top of each other in a simple manner.

Furthermore, it is preferably provided that the transport device is arranged on the printing table or on a housing carrying the printing table or assigned to the printing table. In a first embodiment, the transport device is thus arranged on the printing device, in particular on the printing table or the printing head, or on a housing of the printing device. The transport device is preferably arranged on the printing device. The actuation and the actuator system for moving the printing screens on the printing device itself are thus provided. This has the advantage that, for example, a screen magazine can also be replaced without interfering with the operation of the printing device. The printing device can thus also access different printing magazines. For this purpose, the printing system preferably has a plurality of printing magazines. This increases the variety of different printing screens.

According to an alternative embodiment of the invention, the transport device is arranged on the screen magazine. The transport device can thus be entrained with the screen magazine. The printing device itself can thereby be designed to be more space-saving. Furthermore, this results in the advantage that an existing printing device can also be supplemented subsequently by the screen magazine with transport device, in order to enable automated screen replacement for already existing screen printing devices.

In another embodiment of the invention, it is preferably provided that the transport device is arranged between the screen bearing and the printing table and is formed separately therefrom. The transport device is thus present in a manner both detached from the printing device and detached from the screen magazine, and interacts with both. A simple adaptation of the printing system to different installation space conditions is thereby possible in a particularly simple manner.

A preferred embodiment of the invention provides for the transport device to have at least one movable, in particular a multi-link arm, for transporting a printing screen in each case. The arm, which as such can also be called a robot arm, ensures a simple and targeted transport of the printing screen from the screen magazine to the print head or from the print head from the screen magazine. In particular, a plurality of screen magazines can be operated by the movable arm. It is also conceivable to operate a plurality of printing devices for screen exchange by means of the transport device.

In a preferred embodiment of the invention, the screen magazine has a plurality of screen bearings stacked on top of each other for receiving a respective printing screen. The printing screens are thus held in the screen magazine in printing bearings. The fact that the screen bearings are arranged or stacked on top of one another results in an advantageous utilization of installation space.

The screen magazine preferably has at least one sliding device for advancing a screen bearing or a printing screen from one of the screen bearings. By means of the sliding device, the printing screen can be advanced at least to such an extent that the transport device can grip the printing screen and feed it to the printing device. By means of the sliding device, it is achieved that the selected printing screen can be removed more simply from the affected screen bearing by the transport device. Alternatively, the transport device alone removes the printing screen from the selected screen bearing.

In a preferred development of the invention, the transport device has a lifting device for moving the screen bearings in height. As a result, it is achieved, for example, that the transport device always removes the printing screen from the same height from the printing magazine by displacing the screen bearings correspondingly in height. The printing screens stored in the screen magazine can thereby be protected particularly advantageously. In particular, it is provided that the screen magazine has a housing which is at least essentially closed and has at least one removal opening, through which the respectively selected printing screen can be pushed through the sliding device or directly removed by the transport device. Preferably, the removal opening is only slightly larger here than one of the printing screens to be removed, so that access to the interior of the screen magazine is particularly small, as a result of which the contamination of the screens located in the screen bearing is advantageously prevented.

In a preferred development, the sliding device is designed to displace a selected printing screen from one of the screen bearings into the screen receptacle and/or vice versa. In particular in conjunction with the aforementioned lifting device, the transport device can thereby for example first displace a selected printing screen to the removal height and feed it directly to the screen receptacle of the printing device by means of the pushing device. The printing device then preferably likewise has a pushing device, or the pushing device of the transport device is also designed as a drawing device, by means of which the printing screen located in the screen receptacle can be moved back into the screen magazine. As a result, the movable transport arm can be completely dispensed with.

Furthermore, the screen magazine is preferably arranged on the printing device. As a result, the screen magazine forms part of the printing device and can be entrained overall therewith. A particularly compact unit of the printing system can thereby be created.

Alternatively, the screen magazine is preferably arranged next to and at a distance from the printing table. As a result, it forms a separate unit and can be transported and mounted detached therefrom.

Furthermore, it is preferably provided that the transport device has at least one controllable gripper for holding and transporting a printing screen, in particular at a free end of the transport arm. The respective printing screen can thereby be reliably moved by the transport device.

Furthermore, it is preferably provided that the screen magazine has a conditioning device for air-conditioning or conditioning the printing screens in the screen bearings. The conditioning device is designed, in particular, to air-condition or condition the printing screens in such a way that printing materials remaining on the printing screens do not dry as residues and can be reused again during a later printing process. Thereby, the cleaning of a printing screen after a printing process is not necessary. This saves material resources, on the on hand, and time in the production of the three-dimensional structure, on the other hand. The conditioning device then also includes, in particular, the previously mentioned housing of the screen magazine or an additional housing, which ensures that the climate generated in the screen magazine remains in place. The removal opening of the housing can preferably be displaced by a separating element, so that conditioning takes place in a particularly lasting manner and the energy expenditure for conditioning is kept low. For air-conditioning purposes, the conditioning device preferably comprises an air-conditioning system with a heating and/or cooling device, as well as an air humidifier and/or dehumidifier, by means of which the optimum climate for the screens located in the pressure magazine can be set. If the printing system has a plurality of screen magazines, the screen magazines can also be configured identically or in particular differently with regard to the conditioning, so that, for example, a screen magazine is optimized for conditioning a printing compound from a first material and the means of another screen magazine are optimized for conditioning a printing compound from another material.

The printing system preferably has a plurality of identical and/or different printing screens which, depending on the application, can be selected by the transport device and fed to the printing device. For example, it is also possible for two identical printing screens to be present, which, however, are impinged upon by different materials for the printing material. As a result of the conditioning of the screen magazine, whether the respective printing screen remains in the screen bearing for a long time or only briefly does not matter, so that, as a whole, an optimized resource consumption and an optimized time division and an automated production of three-dimensional structures are ensured safely and cost-effectively.

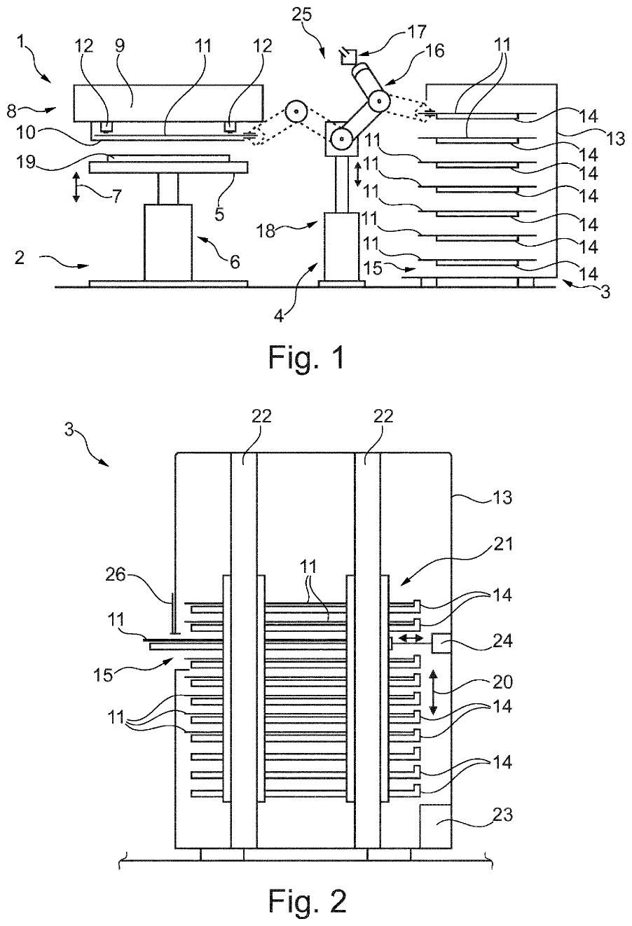

FIG. 1 shows in a simplified side view a printing system 1 comprising a printing device 2, a screen magazine 3 and a transport device 4.

The printing device 2 has a printing table 5, which is adjustable in height by a lifting device 6 as indicated by a double arrow 7. A printing head 8 which has a scraper device 9 is associated with the printing table 5. In addition to a scraper blade, which is not shown here in greater detail, the scraper blade device 9 has a screen receptacle 10, in which a printing screen 11 can be arranged. For this purpose, the screen receptacle 10 is designed, for example, as a receptacle into which the printing screen 11 can be inserted, in particular inserted laterally or horizontally, as shown in FIG. 1. Alternatively, the screen receptacle 10 is designed in such a way that the printing screen 11 can be inserted therein. Optionally, the screen receptacle 10 has controllable clamping elements 12, by means of which the printing screen 11 can be clamped in the screen receptacle 10, so that in a printing process in which the scraper blade of the scraper device 9 is moved over the printing screen 11, the orientation and position of the printing screen 11 does not change. The screen magazine 3 has a housing 13 and is arranged at a distance from the printing device 2 in the present case. In the housing 13 a plurality of screen bearings 14 are arranged in a manner superimposed or stacked one above the other. The screen bearings 14 are designed, for example, like the screen receptacle 10 and optionally also have the clamping elements 12. A printing screen 11 can be arranged in each screen bearing 14. The housing 13 is essentially closed, but has, on a side facing the printing device 2 in particular, a removal opening 15, through which a printing screen 11 can be introduced into or out of the housing 13.

The transport device 4 is designed to move the printing screens 11. This has, in the present exemplary embodiment, a multi-link transport arm 16, which carries a gripper 17 at its free end. The gripper 17 is designed, for example, pneumatically or mechanically, in order to grip a single printing screen 11. The transport device 4 is arranged between the printing device 2 and the screen magazine 3 in such a way that the transport arm 16 can reach both a printing screen 11 assigned to the removal opening 15 and a printing screen 11 laid down in the screen receptacle 10. In the present exemplary embodiment, the removal opening 15 extends virtually over the entire height of the screen magazine 3, wherein the transport arm 16 is designed in such a way that it can reach each screen bearing 14 or the printing screen located therein. To this end, the transport device 4 is optionally equipped with its own lifting device 18, in order to increase the freedom of movement of the gripper 17. Together with the screen magazine 3, the transport device 4 forms a screen provisioning device 25 for the printing device 2.

The function of the advantageous printing system 1 is as follows. For printing three-dimensionally shaped structures, the transport device 4 is first controlled to remove a specific printing screen 11 from the screen magazine 3 and feed it to the screen receptacle 10. The printing screen 11 is locked in the screen receptacle 10 by means of the clamping means 12. The printing screen 11 is acted upon by a printing material, in particular a printing paste, of a selected material, and a scraper blade of the scraper blade device 9 is pushed over the printing screen 11, so that the printing material is imprinted onto the printing table through the printing screen 11. In this case, it is conceivable for the printing material to be applied directly to the printing table 5 or to a substrate 19 arranged on the printing table 5 which can be embodied, for example, as a carrier substrate or also as a printed circuit board, wafer or the like. For this purpose, the printing screen 11 has screen openings in certain areas, which correspond to the desired first layer of the structure to be printed. In this case, many such structures can be incorporated into the printing screen 11, so that a plurality of components or structural elements/structures can also be produced simultaneously adjacent to a printing process on the substrate 19 and/or the printing table 5.

After the first printing layer has been produced, the printing table 7 is moved downward by the lifting device 6 for example, and a further printing operation is carried out, with which the same printing screen 11 is used to produce a further printing layer which has the same structure as the first printing layer. Optionally, instead of the same printing screen 11 one of the other printing screens 11 is used. For this purpose, the transport arm 16 moves the printing screen 11 located in the screen receptacle 10 into the screen magazine 3, specifically into a screen bearing 14 which is free there. At the same time, the transport arm 16 removes another screen 11 from another screen bearing 14 and feeds it to the screen receptacle 10 of the printing device 2. In a subsequent printing process, a printing layer is then produced, for example, which differs in shape from the previous printing layer. This principle makes it possible to produce a plurality of printing layers one above the other which differ from one another, as a result of which complex three-dimensional structures can also be produced. After each printing process has taken place, the printing table 5 is lowered a bit or, alternatively, the printing head 9 is lifted a bit.

While it is provided in the exemplary embodiment of FIG. 1 that the screen bearings 14 are firmly arranged in the housing 13, according to a further exemplary embodiment, which is shown in a simplified representation in FIG. 2, it is provided that the screen bearings 14 are movable in height in the housing 13, as shown by a double arrow 20. For this purpose, the screen bearings 14 can be displaced along vertical rails 22 by means of a lifting device 21. In this case, the removal opening 15 of the housing 13 is arranged approximately centrally in the housing 13 and is designed so narrow that only one printing screen 11 can be removed from the housing 13 by the transport arm 16 or can be inserted therein. Optionally, the removal opening 15 can be displaced by a separating element 26.

If a specific printing screen 11 is to be removed from the screen magazine 3, the screen bearings 14 are first moved or displaced vertically in such a way that this printing screen 11 is assigned to the removal opening 15 and can be removed from the transport arm 16. The configuration of the housing 13 of the screen magazine 3, which is thereby essentially closed, has the advantage that there is a climate in the screen magazine 3 which improves the retention of the printing screens 11 in the screen magazine 3. Optionally, a conditioning device 23 is arranged in the screening magazine 3, which has, for example, a cooling device or heating device, an air humidifier and/or an air dehumidifier, in order to influence the climate in the screen magazine 3. In particular, the climate is influenced in such a way that residues of the printing compound remaining on the respective printing screen 11 are kept capable of being deposited. Drying is thus prevented. This has the advantage that the printing screens 11 can also be held in the screen magazine 3 over a longer period of time, without having to be cleaned. As a result, the printing material can also be intentionally left on the respective printing screen 11. Therefore, when filling the printing screen 11, less care must be taken to ensure that a maximum amount is used in order to avoid the scrapping or loss of the printing mass due to a cleaning process. Instead, the printing mass is reused as soon as the printing screen 11 is removed from the screen magazine 3 and is used as the basis for a further printing process. Of course, the conditioning device 23 can also be provided in the exemplary embodiment of FIG. 1.

In principle, the transport device 4 can be integrated completely into the printing device 2 or even completely into the screen magazine 3. Optionally, the transport device is partially formed by the printing device and partly by the screen magazine 3. For this purpose, the screen magazine 3 has, for example, a sliding device 24 as shown by way of example in FIG. 2. The sliding device 24 is arranged at the level of the removal opening 15 and serves to advance a screen bearing 14 lying at the height of the removal opening 15 with a printing screen 11 or only the printing screen 11 in the direction of the removal opening 15 in such a way that the printing screen 11 projects beyond the housing 13 and thereby the transport arm 16 can be gripped particularly easily. The transport arm 16 is formed, for example, on the printing device 2.

In another exemplary embodiment, it can be provided that the pushing device 24 is designed in such a way that it pushes the printing screen completely through the removal opening 15 into the screen receptacle 10. If the removal opening 15 and screen receptacle 10 are aligned with one another, this can be realized in a simple and cost-effective manner. The printing device 2 then expediently has a corresponding sliding device which is designed to push the printing screen 11 back into the screen magazine and the screen bearing assigned to the removal opening 15 after a printing process has been carried out.

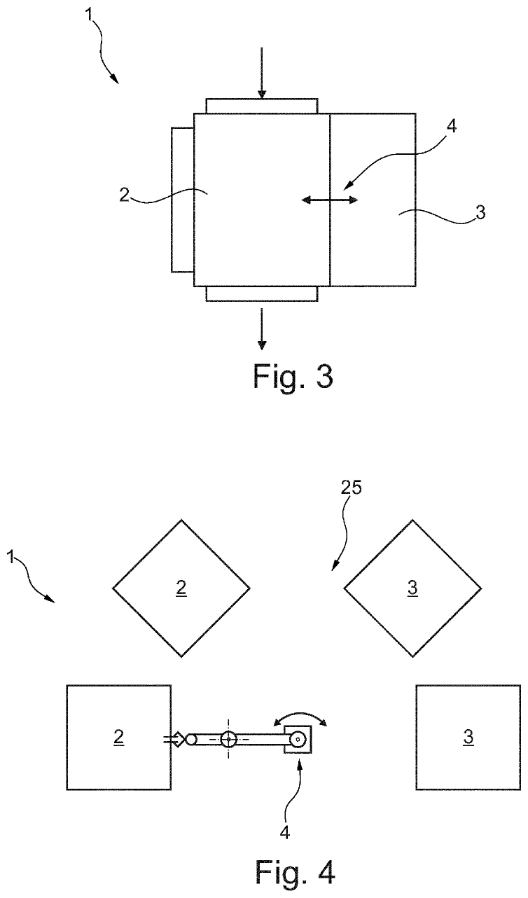

FIG. 3 shows a top view of an advantageous embodiment of the printing system 1. In this case, the printing device 2, the screen magazine 3 and the transport device 4 form one unit. For this purpose, the screen magazine 3 is arranged directly on the printing device 2 and the transport device 4 is arranged on the printing device 2 and/or the screen magazine 3. For example, substrates can then be fed to the printing device from one side and removed on the other side, and the printing screens from another side, as shown in FIG. 3. This provides a particularly compact unit, which can be used in a space-saving manner.

FIG. 4 shows another exemplary embodiment of the printing system 1, with which transport device 4 is formed separately from the printing device 2 and the screen magazine 3. Here, provision is made in the present case for a plurality of printing devices 2 and screen magazines 3, as described above, to be arranged around the transport device 4. In this case, the printing devices 2 and screen magazines 3 lie around the transport device 4 on a circumference, so that the transport arm 16 can operate all screen magazines 3 and printing devices 2. It is thereby possible, by means of a single transport device 4, to populate a plurality of printing devices with selected printing screens and no longer to bring them into a screen magazine 3 for use of the printing screens, in order to store them there. This provides a highly complex three-dimensional printing press, which ensures short throughput times with few rejects.

1. Printing system (1) for printing three-dimensionally shaped structures, in particular on substrates such as printed circuit boards, wafers, solar cells, carrier substrates, printing tables, carrier plates, sintering plates or the like, comprising at least one printing device (2) which has a print head (8) having a scraper device (9) and a screen receptacle (10) which is associated with the scraper device magazine (3) for receiving a printing screen (11), characterized by a screen provisioning device (25) which has at least one screen magazine (3) for storing multiple printing screens (11) and a transport device (4) for transporting a printing screen (11) from the screen magazine (3) to the screen receptacle (10) and from the screen receptacle (10) to the screen magazine (3).

2. Printing system according to claim 1, characterized in that the printing head (8) and/or a printing table (5) can be adjusted in height in order to produce a plurality of printing layers one above the other with identical or different printing screens (11).

3. Printing system according to claim 1, characterized in that the transport device (4) is arranged on the printing device (2), in particular on the print head (8) or on the printing table (5), or on a housing of the printing device (2).

4. Printing system according to claim 1, characterized in that the transport device (4) is arranged on the screen magazine (3).

5. Printing system according to claim 1, characterized in that the transport device (4) is arranged between the screen magazine (3) and the printing table (5) and is embodied separately therefrom.

6. Printing system according to claim 1, characterized in that the transport device (4) has at least one movable, in particular multi-link, transport arm (16) for transporting in each case one printing screen (11).

7. Printing system according to claim 1, characterized in that the screen magazine (3) has multiple screen bearings (14) arranged stacked on top of each other for receiving a printing screen (11) in each case.

8. Printing system according to claim 1, characterized in that the screen magazine (3) has at least one sliding device (24) for advancing a screen bearing (14) or a printing screen (11) from one of the screen bearings (14).

9. Printing system according to claim 1, characterized in that the transport device (4) has a lifting device (18, 21), in particular for moving the screen bearings (14) or the transport arm (16) in height.

10. Printing system according to claim 1, characterized in that the sliding device (24) is designed to displace a selected printing screen (11) from one of the screen bearings (14) into the screen receptacle (10) and/or vice versa.

11. Printing system according to claim 1, characterized in that the screen magazine (3) is arranged on the printing device (2).

12. Printing system according to claim 1, characterized in that the screen magazine (3) is arranged next to and at a distance from the printing device (2).

13. Printing system according to claim 1, characterized in that the transport device (4) has at least one controllable gripper (17), in particular at a free end of the transport arm (16), for holding and transporting a printing screen (11).

14. Printing system according to claim 1, characterized in that the screen magazine (3) has a conditioning device (23) for air-conditioning the printing screens (11) in the screen magazine (3).

15. Printing system according to claim 1, characterized by a plurality of identical and/or different printing screens (11).
